(19) United States
(12) Patent Application Publication
(10) Pub. No.: US 2012/0180621 A1
(43) Pub. Date: Jul. 19, 2012

(54) DRUM HEAD

(75) Inventor: Winfried Holl, Illertissen-Au (DE)

(73) Assignee: GEWA MUSIC GMBH, Adorf (DE)

(21) Appl. No.: 13/241,480

(22) Filed: Sep. 23, 2011

(30) Foreign Application Priority Data
Jan. 13, 2011 (DE) 10 2011 008 512.2

(51) Int. Cl. G10H 3/00; G10D 13/02

(52) U.S. Cl. 84/723; 84/414

(57) ABSTRACT

A drum head (1) for an electric drum (100), the drum head having a first side (11) and a second side (12), wherein the drum head (1) comprises chloroprene rubber and wherein a nylon fabric is provided on the first side (11) of the drum head (1).

### CROSS-REFERENCE TO RELATED APPLICATIONS

This application claims priority and wholly incorporates by reference German application number DE 10 2011 008 512.2 filed Jan. 13, 2011.

### FIELD OF THE INVENTION

The invention is directed to a drum head for an electric drum (electronic drum), an electric drum and use of chloroprene rubber for a drum head of an electric drum.

### BACKGROUND

There are known electric drums, the drum heads of which are formed from a net-like hide. It is a disadvantage of those hides that, when the drums are played, a strong rubber ball-like rebound behaviour and a strong elastic spring-back, respectively, of a drum stick and a mallet, is produced as a consequence.

Moreover, there are known drums, the drum heads of which consist of a natural rubber mixture. Those drum heads have the disadvantage that, due to the surface properties, an increased friction force acts on the mallets, leading to a negative effect on the playing experience and conveying a less realistic playing experience in comparison with acoustic drums.

### SUMMARY OF THE INVENTION

It is an object of the present invention to provide an enhanced drum head for electric drums and an enhanced electric drum which are able to overcome the above-mentioned disadvantages.

This object is achieved by a drum head, an electric drum and an accompanying use described below, along with further developments.

Due to the drum head comprising chloroprene rubber foam as well as nylon fabric, a natural playing experience is ensured which matches the playing experience of conventional acoustic drum kits and drums, respectively. This combination of materials allows for a natural rebound behaviour of the mallet and the drum stick, respectively, and further enhances the playing experience due to small surface friction caused by the nylon fabric.

Further features and advantages of the present invention will become apparent from the description of exemplary embodiments in conjunction with the accompanying drawing.

### BRIEF DESCRIPTION OF THE DRAWINGS

FIG. 1 is an exploded view of a drum, according to an embodiment of the invention.

### DETAILED DESCRIPTION OF THE INVENTION

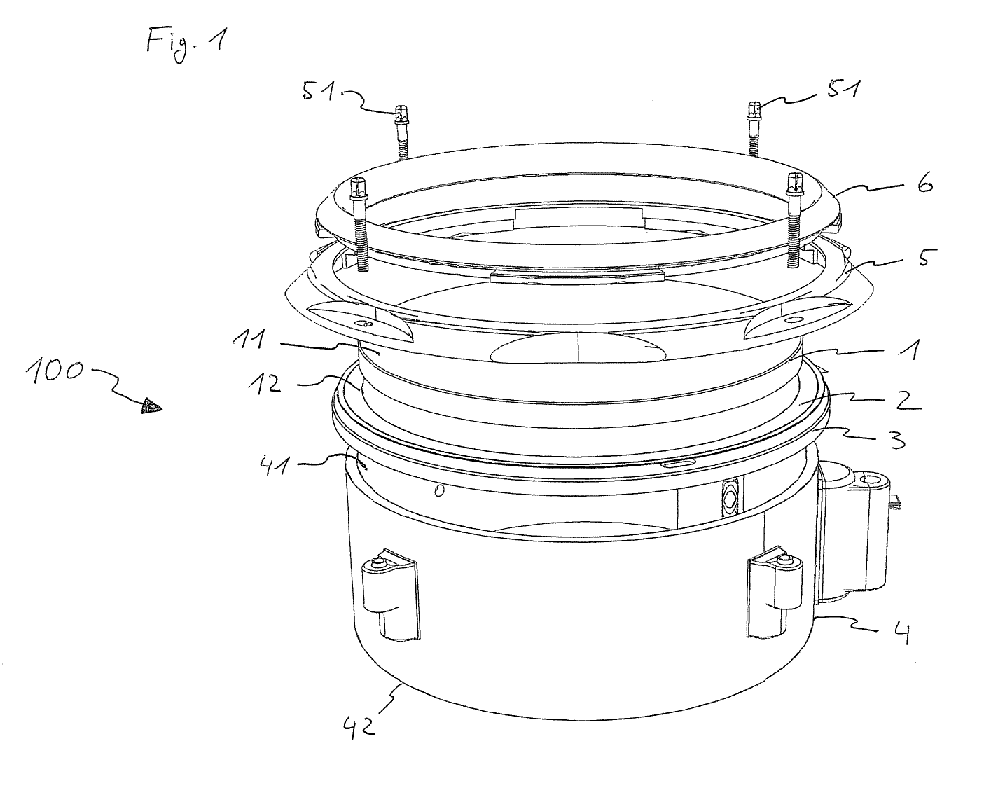

FIG. 1 shows an electric drum 100 or “pad” having a drum head 1 which comprises a first side 11 or strike side 11 and a second side 12, a sensor 2 for detecting contact information, a support plate 3 for accommodating the drum head 1 and the sensor 2, a drum shell 4 having a first end 41 and a second end 42 and being constructed corresponding to a drum shell of a conventional acoustic drum, a tension ring 5 for fixing the drum head 1, and a trigger ring 6.

The tension ring 5 can be fastened to the drum shell 4 by means of four fastening means and screws 51. For this purpose, the drum shell 4 which is essentially formed by a hollow cylindrical body open at both sides, comprises four corresponding screw accommodations into which the screws 51 can be screwed, respectively. In this manner, the support plate 3, the sensor 2 provided on the support plate 3, and the drum head 1 provided on the sensor 2, are clampable. In the embodiment shown, the support plate 3, the sensor 2, and the drum head 1 are formed in a circular plate shape, and the drum shell 4, the tension ring 5, and the trigger ring 6 are formed in a circular ring shape. However, other geometric shapes, as for example a hexagonal shape, are also conceivable.

The trigger ring 6 can be inserted into the tension ring 5 to be twistable, wherein both elements can be locked in place by means of a bayonet locking device.

The support plate 3 and the tension ring 5 are preferably formed from acrylonitrile-butadiene-styrene (ABS resin). The sensor 2 is preferably a pressure-sensitive sensor, as for example a Force Sensing Resistor—FSR®. The trigger ring 6 is preferably made of silicone.

The drum head 1 is made completely or partially from chloroprene rubber foam and chloroprene rubber, respectively, also called polychloroprene or neoprene, which is a cellular rubber and synthetic rubber, respectively, obtained by polymerization and comprising polymers as well as copolymers from chloroprene units. Preferably, a chloroprene rubber produced from SEDO Chemicals Neoprene GmbH is used which has the following properties.

| Type | HS | |
|---|---|---|
| Polymer | Neoprene (CR) | |
| Color | Black | |
| ASTM D-1056-00 Classification | 2C2 | |
| 25% Compression Deflection ₁₎ [kPa] | 35-65 | |
| 50% Compression Set ₂₎ [%] | 25 | max. |
| Density ₃₎ [kg/m³] | 220 ± 30 | |
| Durometer ₄₎ [shore 00] | 45-53 | |
| Impact Resilience ₅₎ [%] | 70 | min. |
| Shrinkage ₆₎ [% linear] | 12 | max. |
| Tensile Strength ₇₎ [N/mm²] | 0.80 | min. |
| Elongation at brake ₈₎ | 200 | min. |

| | |
|---|---|
| Standard Sheet Size [cm] ± 5% | 210 × 125 |
| Standard Bun Thickness [mm] ± 5% | 30 |

₁₎ 25% Compression Deflection ASTM D-1056
₂₎ 50% Compression Set ASTM D-1056
₃₎ Density DIN EN ISO 845
₄₎ Durometer 30 mm Thickness, skin both sides
₅₎ Impact resilience DIN 53 512
₆₎ Shrinkage 20 min./160° C., 30 min.
₇₎ Tensile Strength DIN 53 504, Normstab S 2, oc both sides
₈₎ Elongation at brake DIN 53 504, Normstab S 2, oc both sides

The drum head 1 is coated, preferably with a nylon mesh and a nylon fabric, respectively, on the first side 11. By this arrangement, a surface friction is ensured to be as low as possible, which has a positive effect on the playing experience. Thus, the surface is ideally adapted to drum sticks which are made from wood in most cases, and the friction is minimized, respectively.

It is also conceivable to coat the drum head 1 with a different polyamide fabric and plastic fabric, respectively.

In operation, the drum head 1 transfers the impetuses (momentums) from the mallets to the sensor 2 which detects them and transfers them, for example, to a computer. The trigger ring 6 also passes those impetuses which are produced when the mallets strike the trigger ring 6 itself, to the sensor 2. Due to the specific choice of materials for the drum head 1 described above, the latter one produces a minimum amount of self-noise only which enhances the playing experience in comparison to conventional electric drums.

A combination of nylon fabric or the like as a surface of the drum head 1 with which the mallets come into contact, and the chloroprene rubber foam layer arranged therebelow and having Neoprene® properties, leads to outstanding playing properties which confer the drum player the impression of playing on an acoustic drum. Correspondingly, also materials similar to chloroprene rubber foam having similar properties as Neoprene®, are covered by the present invention.

1-10. (canceled)

11. A drum head for an electric drum, the drum head having a first side and a second side, wherein the drum head comprises chloroprene rubber and wherein a nylon fabric is provided on the first side of the drum head.

12. The drum head according to claim 11, wherein the chloroprene rubber is a chloroprene rubber foam.

13. The drum head according to claim 11, wherein the first side of the drum head is coated with a nylon fabric.

14. An electric drum, comprising
a drum head according to claim 11,
a drum shell having a first end and a second end,
a support plate for accommodating the drum head,
a sensor for detecting contact information, wherein the sensor is provided between the drum head and the support plate, and
a tension ring for fixing the drum head, the sensor, and the support plate in relation to the drum shell.

15. The electric drum according to claim 14, wherein a trigger ring is provided, the trigger ring being insertable into the tension ring in a twistable manner.

16. The electric drum according to claim 15, wherein the trigger ring and the tension ring are lockable in place by a bayonet locking device.

17. The electric drum according to claim 14, wherein the support plate and the tension ring comprise acrylonitrile-butadiene-styrene.

18. The electric drum according to claim 14, wherein the tension ring is fastenable to the drum shell.

19. The electric drum according to claim 14, wherein the drum head, the sensor, and the support plate are clampable between the tension ring and the drum shell.

20. Use of chloroprene rubber for a drum head of an electric drum in combination with a nylon fabric.
